(19) United States
(12) Patent Application Publication
(10) Pub. No.: US 2001/0033111 A1
(43) Pub. Date: Oct. 25, 2001

(54) Resin molded brushless direct current motor and method of manufacturing the same

(76) Inventor: Kyung-Shik Choi, Suwon-city (KR)

Correspondence Address: Elaine H. Lo, SKJERVEN MORRILL MacPHERSON LLP, 25 Metro Drive, Suite 700, San Jose, CA, 95110-1349, US

(21) Appl. No.: 09/832,076

(22) Filed: Apr. 9, 2001

(30) Foreign Application Priority Data
Apr. 21, 2000 (KR) 2000-21216

(51) Int. Cl. H02K 1/04

(52) U.S. Cl. 310/43; 310/89

(57) ABSTRACT

A resin molded brushless direct current motor includes a rotor assembly and a stator assembly. The rotor assembly includes a rotor, which has a plurality of permanent magnets for creating a magnetic field, and a rotating shaft. The stator assembly includes a plurality of multi-phase coils, which create an electric field for generating a torque in cooperation with the magnetic field created by the magnets of the rotor. The motor further includes an injection molded housing and a control board disposed on an outer portion of the housing. The control board has a drive circuit for detecting a position of the rotor and sequentially applying conducting signals to the multi-phase coils of the stator assembly. Connection pins, which are connected to multi-phase coils of the stator assembly, project from one end of the housing and mate with connectors formed on the control board. Since the control board is added after the housing has been injection molded, there is no possibility for the control board to be damaged by the high temperature of injection molding process

### BACKGROUND OF THE INVENTION

1. Field of the Invention

The present invention relates to a brushless direct-current (BLDC) motor, and more particularly, to a resin molded BLDC motor having a housing that is injection molded with resin. The present invention also relates to a method of manufacturing the BLDC motor.

2. Description of the Related Art

As well known in the art, a BLDC motor has a control board in which a drive circuit for detecting a position of a rotor and then sequentially applying conducting signals to multiphase coils that are wound on a stator is disposed. The resin molded BLDC motor has a housing that is injection molded with resin. The housing is injection molded in a manner such that the resin encapsulates the stator and the multi-phase coils.

A typical example of such a resin molded BLDC motor is illustrated in FIGS. 1 and 2, which provide a perspective view and a cross-sectional view, respectively.

As shown in FIGS. 1 and 2, the conventional resin molded BLDC motor includes a rotor assembly 1, a stator assembly 2, a control board 3 and a housing 4.

The rotor assembly 1 comprises a rotor 11 which has a plurality of permanent magnets for creating a magnetic field, and a rotating shaft 12, which is press-fit through a shaft hole of the rotor 11.

The stator assembly 2 comprises a stator 21, which is formed by a stack of cores, and coils 23 that are wound on the stator 21 through slots defined in the stator 21. Insulators 22 are interposed between the stator 21 and the coils 23. The coils 23 create an electric field that interacts with the magnetic field created by the permanent magnets of the rotor 11 so as to generate a torque.

The control board 3 has a drive circuit that detects the position of the rotor 11 and then sequentially applies conducting signals to the multi-phase coils 23 that are wound on the stator 21. One end of the control board 3 is installed on and supported by the insulators 22, which extend from the stator assembly 2. The multi-phase coils 23, which are wound on the stator 21 through the slots, are connected to the control board 3.

The housing 4 is formed by an injection molding process using a resin to fill in a predetermined space including the stator assembly 2 and the control board 3. In other words, after the control board 3 is coupled to the stator assembly 2, this provisional assembly is inserted into a mold and is injection molded using resin to form the housing 4. The injection molding process typically lasts for 300 seconds at a temperature of about 120° C.

The BLDC motor further includes bearings 5 and 6 for rotatably supporting the rotating shaft 12, bearing covers 7 and 8, and bearing supporting springs 9 and 10. The BLDC motor also includes a power connector 50 for supplying power to the motor.

Hereinafter, a method of manufacturing the conventional resin molded BLDC motor will be described in detail with reference to FIG. 3.

First, at step S10, the stator assembly 2 is assembled. The insulators 22 are inserted into the respective slots of the stator 21, and the coils 23 are wound. At step S20, the ends of the respective coils 23 of the stator assembly 2 are soldered to the control board 3, thereby enabling the control board 3 to be supported by the insulators 22 of the stator assembly 2.

At step S30, the stator assembly 2 and the control board 3, which were provisionally assembled at step S20, are inserted into the mold, and the housing 4 is injection molded with a resin. Next, at step S40 the rotor assembly 1 is assembled to the housing 4, which was formed by the earlier injection molding process. Finally, at step S50 the bearing covers 7 and 8 are press-fit onto the ends of the housing 4.

The conventional resin molded BLDC motor suffers from several drawbacks. Because the control board 3 is injection molded along with the stator assembly 2, and the injection molding process occurs at a high temperature (of about 120° C.), the control board 3 can be damaged by the heat. If there is a defect in the control board 3, the entire resin molded assembly may need to be discarded. As a result, the present manufacture process can result in increased cost and waste. In addition, the reliability of the resulting BLDC motor is affected by any damage to the control board 3 due to the high temperature generated in the injection molding process.

### SUMMARY OF THE INVENTION

Accordingly, the present invention has been made in an effort to solve the problems that occur in the related art. It is an object of the present invention to provide a resin molded BLDC motor, in which a housing is injection molded separately from a control board to prevent damage to the control board from a high temperature generated during the injection molding process, thereby minimizing the number of defective control boards. Another object of the present invention is to provide a method of manufacturing method such a BLDC motor.

In accordance with one aspect of the present invention, a resin molded BLDC motor includes a rotor assembly and a stator assembly. The rotor assembly includes a rotor, which has a plurality of permanent magnets for creating a magnetic field, and a rotating shaft. The stator assembly includes multi-phase coils, which create an electric field for generating a torque in cooperation with the magnetic field created by the permanent magnets of the rotor, a control board having a drive circuit for detecting a position of the rotor and sequentially applying conducting signals to the multi-phase coils of the stator assembly, and a housing. The housing is formed by an injection molding process, using resin to allow a mold of a predetermined space, with the stator assembly inserted therein, to be filled with the resin.

Connection pins project to the outside from one end of the housing. Each connection pin is connected to a respective multi-phase coil of the stator assembly. The connection pins mate with connectors that are formed on the control board. Consequently, after the housing has been injection molded, the control board can be mounted to the housing by coupling the connection pins and the connectors together such that the control board is disposed on an outer portion of the housing.

The resin molded BLDC motor further comprises a pair of bearings for rotatably supporting the rotating shaft of the rotor assembly, and a pair of bearing covers that are press-fit onto the ends of the housing so as to support the pair of bearings, respectively. Here, one of the pair of bearing covers includes extended portions that extend in a radial direction of the bearing cover, so as to prevent the control board disposed on the outer portion of the housing from being exposed.

In accordance with another aspect of the present invention, a method of manufacturing a resin molded BLDC motor is provided. The method includes assembling a stator assembly, forming a housing by an injection molding process, using resin to allow mold having a predetermined space, including the stator assembly, to be filled with the resin, and electrically connecting a control board to the stator assembly, which is encapsulated by the housing. The method further includes assembling a rotor assembly and inserting it into the housing and press-fitting bearing covers onto the ends of the housing.

The step of assembling the stator assembly includes forming a stator by stacking a plurality of stator cores, inserting insulators into slots that are defined in the stator, winding multi-phase coils on the stator through the slots, and connecting connection pins to the multi-phase coils, which are wound on the stator through the slots.

### BRIEF DESCRIPTION OF THE DRAWINGS

The above objects and other features and advantages of the present invention will become more apparent after a reading of the following detailed description when taken in conjunction with the drawings, in which:

FIG. 1 is a perspective view illustrating a conventional resin molded BLDC motor;

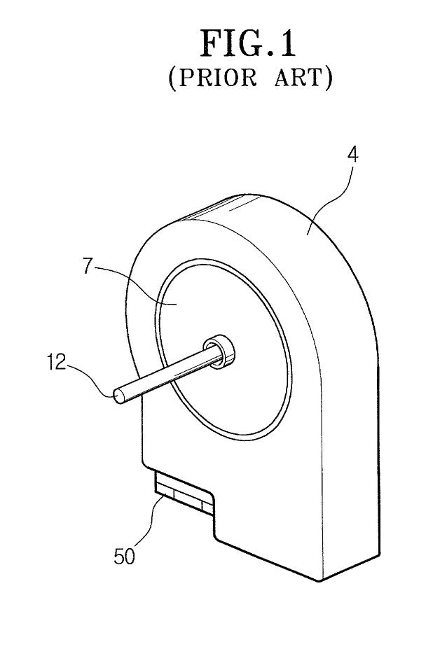

FIG. 2 is a cross-sectional view of the conventional resin molded BLDC motor shown in FIG. 1;

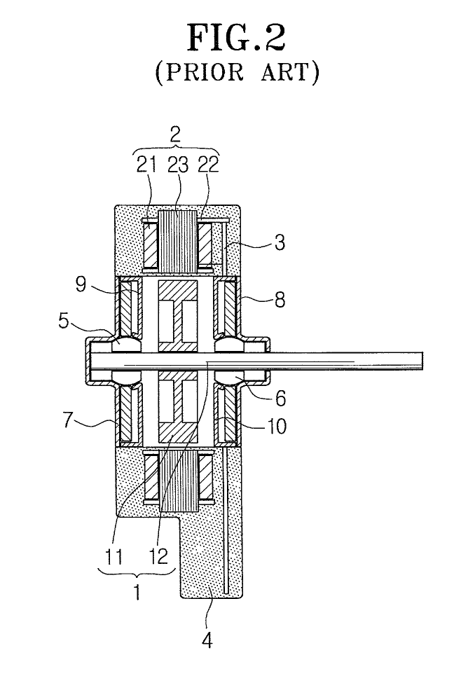

FIG. 3 is a flow chart detailing a method of manufacturing the conventional resin molded BLDC motor shown in FIGS. 1 and 2;

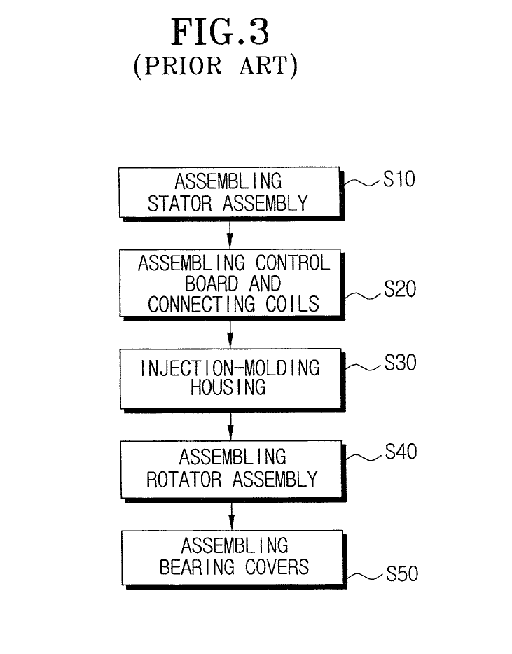

FIG. 4 is a cross-sectional view illustrating a resin molded BLDC motor in accordance with an embodiment of the present invention; and

FIG. 5 is a flow chart detailing a method of manufacturing the resin molded BLDC motor according to the present invention.

### DETAILED DESCRIPTION OF THE PREFERRED EMBODIMENT

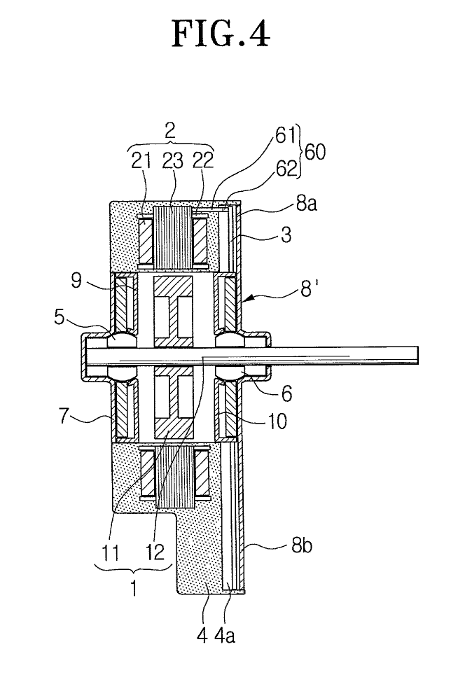

Referring to FIG. 4, there is shown a cross-sectional view of a resin molded BLDC motor in accordance with an embodiment of the present invention. For reference, in describing the embodiment of the present invention, the same reference numerals will be used to designate the parts which have the same structure and function as those of the related art.

As shown in FIG. 4, the resin molded BLDC motor according to the present invention includes a rotor assembly 1, a stator assembly 2, a control board 3, a housing 4 and connection means 60.

The rotor assembly 1 comprises a rotor 11, which has a plurality of permanent magnets for creating a magnetic field, and a rotating shaft 12, which is press-fit through a shaft hole of the rotor 11.

The stator assembly 2 comprises a stator 21, which is formed by a stack of cores, and coils 23, which are wound on the stator 21 through slots defined in the stator 21 with insulators 22 interposed between the stator 21 and the coils 23. The coils 23 create an electric field, which interacts with the magnetic field created by the permanent magnets of the rotor so as to generate a torque.

The housing 4 is formed by an injection molding process, using a resin to fill in a mold having a predetermined space. The stator assembly 2 is inserted into the mold and the housing 4 is injection molded around the stator assembly 2. Unlike the conventional method of forming the housing, the housing 4 is injection molded so that the housing 4 accommodates only the stator assembly 2, rather than both the stator assembly 2 and the control board 3. A depression 4a of a predetermined depth is formed in one end of the housing 4. The depression 4a provides a space for mounting the control board 3 as will be described herein below.

After the housing 4 is injection molded, the control board 3 is mounted to the housing 4 through a subsequent process in a manner such that the control board 3 is placed in the depression 4a of the housing 4. The control board 3 has a drive circuit which detects a position of the rotor 11 and then sequentially applies conducting signals to the multi-phase coils 23 wound on the stator 21.

The connection means 60 electrically connects the control board 3 to the multi-phase coils 23 of the stator assembly 2, which is embedded in the housing 4. The connection means 60 includes connection pins 61 and connectors 62. The connection pins 61 are connected to respective multi-phase coils 23 of the stator assembly 2 and project outward from one end of the housing 4. The connection pins 61 mate with respective connectors 62 that are formed on the control board 3. The connection means 60 provides an electrical connection between the control board 3 and the coils 23 of the stator assembly 2 to enable a desired control operation.

Although in FIG. 4 the connection pins 61 are illustrated as extending radially outward from the stator assembly 2, a person of ordinary skill in the art will readily recognize that the connection pins 61 can also extend radially inward of the stator assembly 2.

The resin molded BLDC motor of the present invention further includes a pair of bearings 5 and 6 for rotatably supporting the rotating shaft 12 of the rotor assembly 1, and a pair of bearing covers 7 and 8′ which are press-fit onto the ends of the housing 4 so as to support the pair of bearings 5 and 6, respectively. The bearing cover 8′ has extended portions 8a and 8b, which extend radially outward from the bearing cover 8′, so as to prevent the control board 3 that is placed in the depression 4a of the housing 4 from being exposed to the outside. The bearing cover 8′ ensures that the control board 3 remains securely connected to the stator assembly 2 in the housing 4.

Bearing support springs 9 and 10 support the bearings 5 and 6, respectively, at inner ends of the bearings 5 and 6. The resin molded BLDC motor also includes a power connector (not shown) for externally supplying power to the control board 3. The power connector is preferably provided at one end of the housing 4.

Hereinafter, a method of manufacturing the resin molded BLDC motor of the present invention will be described in detail.

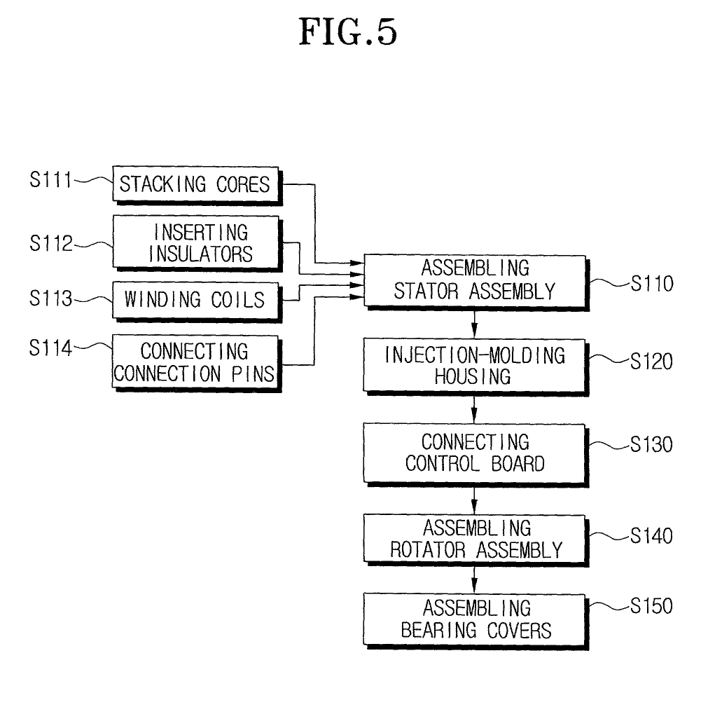

FIG. 5 is a flow chart detailing the method of manufacturing method the resin molded BLDC motor of the present invention.

As can be readily seen from FIG. 5, the manufacturing method of the resin molded BLDC motor according to the present invention includes the steps of assembling the stator assembly 2 (S110), injection molding the housing 4 (S120), connecting the control board 3 to the housing 4 (S130), assembling the rotor assembly 1 (S140), and assembling the bearing covers 7 and 8′ (S150).

The step S110 of assembling the stator assembly 2 includes the steps of forming the stator 21 by stacking a plurality of stator cores (S111), inserting the insulators 22 into the slots, respectively, which are defined in the stator 21 (S112), winding the multi-phase coils 23 on the stator 21 through the slots (S113), and connecting the connection pins 61 to the multi-phase coils 23, respectively, which are wound on the stator 21 through the slots (S114).

The step S120 of injection molding the housing 4 is conducted in a manner such that the stator assembly 2 which is assembled at step S110, is positioned in a mold and injection molded using resin to form the housing 4. The mold for the housing 4 is designed such that the depression 4a is formed in the housing 4 for receiving the control board 3.

The step S130 of connecting the control board 3 is conducted by disposing the control board 3 in the depression 4a of the housing 4. By connecting the connection pins 61, which project from one end of the housing 4, and the connectors 62, which are provided on the control board 3, the control board 3 is mounted to the housing 4 so that the control board 3 and the coils 23 of the stator assembly 2 are electrically connected together.

At step S140 the rotor assembly 1 is assembled inside the housing 4, and at step S150 the bearing covers 7 and 8′ are press-fit onto ends of the housing 4 to complete the assembly of the motor.

One advantage of the resin molded BLDC motor and the manufacturing method thereof is that, since the control board is assembled after the housing has been injection molded, the control board cannot be damaged by the high temperature of the injection molding process. The mold for the housing has a predetermined space and only the stator assembly is inserted into the mold during the injection molding process. The control board is mounted to the housing in a subsequent step.

Hence, because it is possible to reduce the number of defective control boards that are damaged during the high temperature injection molding process, manufacturing cost can be reduced and the reliability of the resulting BLDC motor can be improved.

A preferred embodiment of the invention has been described in the drawings and the specification. Although specific terms are employed, they are used only in a generic and descriptive sense and not for purposes of limitation. Various changes and modifications can be made by one skilled in the art within the spirit and scope of the present invention as hereinafter claimed.

What is claimed is:

1. A resin molded brushless direct current (BLDC) motor comprising:
a rotor assembly including a rotor and a rotating shaft, the rotor having a plurality of magnets for creating a magnetic field;
a stator assembly including a plurality of multi-phase coils, the plurality of multi-phase coils creating an electric field for generating a torque in cooperation with the magnetic field created by the magnets of the rotor;
an injection molded housing encasing the stator assembly;
a control board disposed on an outer portion of the housing, the control board including a drive circuit for detecting a position of the rotor and sequentially applying conducting signals to the multi-phase coils of the stator assembly; and
connection means for electrically connecting the control board to the multi-phase coils of the stator assembly, wherein the housing is injection molded with the stator assembly therein.

2. The resin molded BLDC motor as claimed in claim 1, wherein the outer portion of the housing has a depression formed therein, the control board being disposed in the depression.

3. The resin molded BLDC motor as claimed in claim 1, further comprising a pair of bearings and a pair of bearing covers, the bearings rotatably supporting the rotating shaft of the rotor assembly, each bearing cover being press-fit onto an end of the housing so as to support the respective bearing, one of bearing covers having an extended portion extending radially outward, the bearing cover with the extended portion preventing the control board from being exposed.

4. The resin molded BLDC motor as claimed in claim 1, wherein the connection means comprises:
a plurality of connection pins coupled to respective multi-phase coils of the stator assembly and projecting from the housing; and
a plurality of connectors formed on the control board, each of the connectors corresponding to and mating with a respective connection pin.

5. A method of manufacturing a resin molded brushless direct current motor comprising:
assembling a stator assembly;
forming a housing to encapsulate the stator assembly, the housing being injection molded using a resin and a mold, the stator assembly being placed in the mold;
electrically connecting a control board to the stator assembly;
assembling a rotor assembly to the housing; and
press-fitting a plurality of bearing covers into the ends of the housing.

6. The method as claimed in claim 5, wherein assembling the stator assembly comprises:
forming a stator by stacking a plurality of stator cores, the stator including a plurality of slots formed therein;
inserting a plurality of insulators into the slots of the stator;
winding a plurality of multi-phase coils on the stator through the slots; and
connecting connection pins to the multi-phase coils, respectively, which are wound on the stator through the slots.

7. The method as claimed in claim 5, wherein forming the housing includes forming a depression in an outer portion of the housing, and wherein the control board is disposed in the depression of the housing.
